(19) United States
(12) Patent Application Publication
(10) Pub. No.: US 2018/0372963 A1
(43) Pub. Date: Dec. 27, 2018

(54) FIBER OPTIC CABLE CONNECTOR FOR A RUGGED ENVIRONMENT

(71) Applicant: ZEVULUN MARINE SYSTEMS LTD., Kfar Adumim (IL)

(72) Inventors: Moshe BAR-HAI, Rehovot (IL); Eliav BAR-HAI, Moshav Avnei Eitan (IL); Yaakov MELAMED, Kfar Adumin (IL)

(21) Appl. No.: 15/756,134

(22) PCT Filed: Mar. 9, 2017
(86) PCT No.: PCT/IL2017/050299

§ 371 Date: Feb. 28, 2018

Related U.S. Application Data
(60) Provisional application No. 62/306,192, filed on Mar. 10, 2016.

(51) Int. Cl. G02B 6/38; G02B 6/42; H04B 10/40

(52) U.S. Cl. CPC G02B 6/3897; G02B 6/3817; G02B 6/3825; G02B 6/4246; H04B 10/40; G02B 6/3849

(57) ABSTRACT

A fiber optic cable with a connector for a rugged environment, including a connector assembly, a fiber optic cable entering a back side of the connector assembly, wherein the fiber optic entering the back side of the connector assembly is sealed to the back side of the connector, a transceiver housed in the connector assembly, wherein the fiber optic cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly. Related apparatus and methods are also described.

### RELATED APPLICATION

This application is related to co-filed, co-pending and co-assigned U.S. Provisional Patent Application entitled “CONNECTOR FOR WITHSTANDING HIGH PRESSURE” by Moshe BAR-HAI et al., the disclosure of which is incorporated herein by reference.

### FIELD AND BACKGROUND OF THE INVENTION

The present invention, in some embodiments thereof, relates to a fiber optic cable connector for connecting and/or disconnecting in a rugged environment, and, more particularly, but not exclusively, to such a connector which houses an optic-to-electric signal transceiver and a power converter for the transceiver.

Additional background art includes:

U.S. Pat. No. 7,854,554;

U.S. Patent Application Publication Number 2007/0036489;

U.S. Pat. No. 9,134,493;

U.S. Pat. No. 7,708,474;

The disclosures of all references mentioned above and throughout the present specification, as well as the disclosures of all references mentioned in those references, are hereby incorporated herein by reference.

### SUMMARY OF THE INVENTION

Fiber optic enables very high data rates, over long distances, and may benefit from additional useful features of optical signal conveyance. Connecting a fiber optic cable to another system, whether another fiber optic cable/system or an electric signal system, should be done under clean conditions. Making such a connection under ‘field conditions’, such as underwater, or under sandy, dusty, oily or dirty conditions might result in loss of the connection, or excessive signal loss.

An aspect of some embodiments relates to providing an optic-to-electric signal transceiver packaged in a connector so that the connection made is an electric-to-electric connection. Such electric-to-electric connections can be better protected against environmental deterrents. The transceiver requires electric power, and in some embodiments a power converter component is also packaged within the connector, suitable for powering the transceiver.

According to an aspect of some embodiments of the present invention there is provided a fiber optic cable with a connector for a rugged environment, including a connector assembly, a fiber optic cable entering a back side of the connector assembly, wherein the fiber optic entering the back side of the connector assembly is sealed to the back side of the connector, a transceiver housed in the connector assembly, wherein the fiber optic cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly.

According to some embodiments of the invention, the power converter is electrically connected to a face-side electric contact of the connector assembly.

According to some embodiments of the invention, the power converter is electrically connected to an electric conductor entering the connector assembly from a back side of the connector assembly.

According to some embodiments of the invention, the electric conductor entering the connector assembly from a back side of the connector assembly includes and electric conductor included in the fiber optic cable.

According to some embodiments of the invention, further including a gasket on the face side of the connector assembly, configured to let the face-side electric contact pass through the gasket and to form a waterproof seal against the electric contact.

According to some embodiments of the invention, the connector further includes

an insert including passageways to let the face-side electric contact pass through the insert, and a support, wherein the insert includes a surface designed to direct force exerted by pressure on a front face of the insert sideways toward the support, the support includes a first, inner, surface designed to push back against the sideways force exerted by the insert, and an outer surface designed to brace against an inside of the connector assembly.

According to some embodiments of the invention, the fiber optic cable further includes an electric conducting cable.

According to some embodiments of the invention, the fiber optic cable entering the back side of the connector assembly is sealed against a pressure of up to 20,000 PSI.

According to some embodiments of the invention, the transceiver includes a transceiver type comprising SFP (Small Form-factor Pluggable), SFP+(advanced Small Form-factor Pluggable), XFP (10 Gigabit Small Form-Factor Pluggable), QSFP (Quad Small Form-factor Pluggable), QSFP+(advanced Quad Small Form-factor Pluggable), CSFP (Compact Small Form-factor Pluggable), CFP (C Form-factor Pluggable), and CXP (advanced C form-factor Pluggable).

According to some embodiments of the invention, the transceiver includes an optic fiber interface comprising LC (Lucent Connector), LC duplex (two “Lucent Connectors), SC (Subscriber Connector), FC (Ferrule Connector), MPO (Multiple-Fiber Push-On), MTP (Multiple-Fiber Pull-off), SMA (Sub Miniature A), SMC (Sub Miniature C), ST (Straight Tip), and BFOC (Bayonet Fiber Optic Connector).

According to some embodiments of the invention, the transceiver includes an electric signal interface comprising RJ-45, RS-232, BNC, USB, and HDMI.

According to some embodiments of the invention, the power converter accepts alternating current (AC) input power at any voltage range from 5 volts to 250 volts.

According to some embodiments of the invention, the power converter accepts direct current (DC) input power at any voltage range from 2 volts to 60 volts.

According to some embodiments of the invention, further including potting material.

According to an aspect of some embodiments of the present invention there is provided a fiber optic connector kit for a rugged environment, including a connector assembly including a fiber optic cable entrance at a back side of the connector assembly, a transceiver housed in the assembly, a power converter packaged in the connector assembly, wherein the power converter is electrically connected to the transceiver, and an electrical connection electrically connected on a first side to an electrical signal contact in the transceiver and on a second side to a face-side electrical contact of the connector assembly, and an adapter designed to accept an end of a fiber optic cable and seal the fiber optic cable to the connector assembly enabling rating of up to IP69K.

According to some embodiments of the invention, the adapter is designed to accept an end of a fiber optic cable which includes an electric conducting cable and seals the fiber optic cable to the connector assembly enabling rating of up to IP69K.

According to an aspect of some embodiments of the present invention there is provided a fiber optic cable connector for a rugged environment, including a connector assembly, a fiber optic cable entering a back side of the connector assembly, a transceiver housed in the connector assembly, wherein the fiber optic cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly.

According to some embodiments of the invention, the cable connector is mounted through a wall.

According to an aspect of some embodiments of the present invention there is provided a method of providing a fiber optic cable with a connector for a rugged environment, including providing a connector assembly, providing a fiber optic cable entering a back side of the connector assembly, wherein the fiber optic entering the back side of the connector assembly is sealed to the back side of the connector assembly, providing a transceiver housed in the connector assembly, wherein the fiber optic cable is attached to the transceiver, providing a power converter packaged in the connector assembly, wherein the power converter is electrically connected to the transceiver, and providing an electrical connection electrically connected on a first side to an electrical signal contact in the transceiver and on a second side to a face-side electric contact of the connector assembly.

According to an aspect of some embodiments of the present invention there is provided a method of providing a fiber optic cable connector kit for a rugged environment, including providing a connector assembly including a fiber optic cable entrance at a back side of the connector assembly, a transceiver housed in the assembly, a power converter packaged in the connector assembly, wherein the power converter is electrically connected to the transceiver, and an electrical connection electrically connected on a first side to an electrical signal contact in the transceiver and on a second side to a face-side electric contact of the connector assembly, and providing an adapter designed to accept an end of a fiber optic cable and seal the fiber optic cable to the connector assembly enabling rating of up to IP69K.

According to an aspect of some embodiments of the present invention there is provided a fiber optic cable with a connector assembly for a rugged environment, including a connector assembly having a back side opening and a face side opening, wherein a fiber optic cable for transmitting an optic signal enters a back side opening of the connector assembly, and the back side opening of the connector assembly is sealed to the fiber optic cable, the connector assembly includes an optic-signal to electric signal transceiver, for converting optic signals to electric signals, and a face side of the connector assembly includes a connector shell with only an electrical contact, for transmitting an electric signal, and the connector shell is sealed to the connector assembly.

According to some embodiments of the invention, further including a transceiver housed in the connector assembly, wherein the fiber optic cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly.

According to an aspect of some embodiments of the present invention there is provided an electric signal cable with a connector for a rugged environment, including a connector assembly, an electric signal cable entering a back side of the connector assembly, wherein the electric signal cable entering the back side of the connector assembly is sealed to the back side of the connector, a transceiver housed in the connector assembly, wherein the electric signal cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly.

According to some embodiments of the invention, the power converter is electrically connected to a face-side electric contact of the connector assembly.

According to some embodiments of the invention, the power converter is electrically connected to an electric conductor entering the connector assembly from a back side of the connector assembly.

According to some embodiments of the invention, further including a gasket on the face side of the connector assembly, configured to let the face-side electric contact pass through the gasket and to form a waterproof seal against the electric contact.

According to some embodiments of the invention, the connector further includes an insert including passageways to let the face-side electric contact pass through the insert, and a support, wherein the insert includes a surface designed to direct force exerted by pressure on a front face of the insert sideways toward the support, the support includes a first, inner, surface designed to push back against the sideways force exerted by the insert, and an outer surface designed to brace against an inside of the connector assembly.

According to some embodiments of the invention, the cable entering the back side of the connector assembly is sealed against a pressure of up to 20,000 PSI.

According to some embodiments of the invention, the transceiver includes a transceiver type comprising SFP (Small Form-factor Pluggable), SFP+(advanced Small Form-factor Pluggable), XFP (10 Gigabit Small Form-Factor Pluggable), QSFP (Quad Small Form-factor Pluggable), QSFP+(advanced Quad Small Form-factor Pluggable), CSFP (Compact Small Form-factor Pluggable), CFP (C Form-factor Pluggable), and CXP (advanced C form-factor Pluggable).

According to an aspect of some embodiments of the present invention there is provided a system for communicating data signals, the system including a first unit for communicating data signals including a connector for communicating electric signals, a second unit for communicating data signals including a connector for communicating electric signals, and a fiber optic cable with two connector assemblies, one connector assembly at each end of the cable, each one of the connector assemblies including a connector assembly having a back side opening and a face side opening, wherein a fiber optic cable for transmitting an optic signal enters a back side opening of the connector assembly, and the back side opening of the connector assembly is sealed to the fiber optic cable, the connector assembly includes an optic-signal to electric signal transceiver, for converting optic signals to electric signals, and a face side of the connector assembly includes a connector shell with only an electrical contact, for transmitting an electric signal, and the connector shell is sealed to the connector assembly, wherein the first unit is connected to the connector assembly at one end of the fiber optic cable and the second unit is connected to the connector assembly at another end of the fiber optic cable.

According to an aspect of some embodiments of the present invention there is provided a first connector for a rugged environment connected to a second connector for a rugged environment, including a first connector assembly and a second connector assembly, each one of the connector assemblies including, a fiber optic cable entering a back side of the connector assembly, wherein the fiber optic entering the back side of the connector assembly is sealed to the back side of the connector, a transceiver housed in the connector assembly, wherein the fiber optic cable is attached to the transceiver, a power converter packaged in the connector assembly, wherein the power converter is electrically connected to the transceiver, and an electrical connection electrically connected on a first side to an electrical signal contact in the transceiver and on a second side to a face-side electric contact of the connector assembly, wherein the first connector and the second connector are mated to each other.

According to an aspect of some embodiments of the present invention there is provided a method of sending a signal over fiber optic cable including sending an electric signal through a metal contact in a first connector, receiving the electric signal through a metal contact in a second connector mated with the first connector, converting the electric signal to an optic signal in an optic-to-electric signal transceiver housed within the second connector, and sending the optic signal through a fiber optic cable.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of a prior art method of using fiber optic cable for carrying signals;

FIG. 2A is a simplified block diagram illustration of a fiber optic cable connector for a rugged environment constructed according to an example embodiment of the invention;

FIG. 2B is a simplified illustration of transceivers for use in an example embodiment of the invention;

FIG. 2C is a simplified illustration of a fiber optic cable constructed according to an example embodiment of the invention;

FIG. 2D is a simplified block diagram illustration of components in an example embodiment of the invention;

FIG. 2E is a simplified block diagram illustration of components in an example embodiment of the invention implemented as a wall mount;

FIGS. 3A-C are simplified illustrations of fiber optic cable connectors for a rugged environment constructed according to an example embodiment of the invention;

FIG. 3D is a simplified illustration of an exploded view of an example embodiment of the invention;

FIG. 3E is a simplified illustration of the example embodiment of FIG. 3D;

FIG. 4A depicts an example embodiment of the invention;

FIG. 4B depicts a prior art embodiment;

FIG. 5 is a simplified illustration of an example embodiment of the invention;

FIGS. 6A and 6B are simplified illustrations of connectors connected to connectors in a junction box according to an example embodiment of the invention;

FIGS. 6C and 6D are simplified illustrations of connectors connected to a wall according to an example embodiment of the invention;

FIG. 7 is a simplified block diagram illustration of a junction box for cable connectors according to an example embodiment of the invention;

FIGS. 8A and 8B are simplified illustrations of a kit for connecting an optic cable to a connector according to an example embodiment of the invention;

FIG. 9 is a simplified flow chart illustration of a method of providing a fiber optic cable with a connector for a rugged environment according to an example embodiment of the invention;

FIG. 10 is a simplified flow chart illustration of a method of providing a fiber optic connector kit for a rugged environment, according to an example embodiment of the invention; and

FIG. 11 is a simplified flow chart illustration of a method of sending a signal over fiber optic cable according to an example embodiment of the invention.

### DESCRIPTION OF SPECIFIC EMBODIMENTS OF THE INVENTION

The present invention, in some embodiments thereof, relates to a fiber optic cable connector for connecting and/or disconnecting in a rugged environment, and, more particularly, but not exclusively, to such a connector which houses an optic-to-electric signal transceiver and a power converter for the transceiver.

Fiber optic enables very high data rates, over long distances, and may benefit from additional useful features of optical signal conveyance. Connecting a fiber optic cable to another system, whether another fiber optic cable/system or an electric signal system, should be done under clean conditions. Making such a connection under ‘field conditions’, underwater, under sandy, dusty, oily or dirty conditions might result in loss of the connection, or excessive signal loss.

Example embodiments of the invention have electric contacts on an external connector portion which allow environmental durability, enabling optic fiber transfer rates with the durability of an outdoor copper connection.

Connect and Disconnect in Dirty Environment

An aspect of some embodiments relates to provide an optic-to-electric signal transceiver packaged in a connector so that the connection made is an electric-to-electric connection. Such electric-to-electric connections can be better protected against environmental deterrents. Such connections and disconnections may optionally be made in a ‘dirty’ environment, and connectors constructed according to example embodiments of the invention can potentially handle much dirtier or more difficult environments than optic-to-optic connections.

In optic-fiber to optic-fiber connections little to no contamination/dust/oil/dirt/water that is visible under 200× magnification is allowed. Any amount of visible dirt, dust, water, oil or other contaminates destroy the signal for standard or even expanded beam fiber optics.

Some examples of the effect of contamination on fiber optic connections:

A 1-micrometer dust particle on a single-mode core can block up to 1% of the light (a 0.05 dB signal loss).

A 9-micrometer speck is still too small to see without a microscope, but it can completely block the fiber core. These contaminants can be more difficult to remove than dust particles.

An example embodiment of a connector assembly potentially provides performance and contamination resistance as good as the electrical interface built into the connector assembly. When used with a gasket as described herein, the connector assembly can be used in virtually any level and type of contamination.

In some embodiments the transceiver requires electric power, and in some embodiments a power converter component is also packaged within the connector, suitable for powering the transceiver.

Power

An aspect of some embodiments relates to providing power to the transceiver.

In some embodiments, an electric contact on a face of the connector connects to a source of electric power on a mating connector, and provides electric power to a power converter packaged within the connector. In some embodiments, the power converter optionally receives a wide range of input voltages and provides power suitable for powering any of a range of transceivers.

In some embodiments, the optic fiber cable includes an electric conductor which provides electric power to a power converter packaged within the connector. In some embodiments, the power converter optionally receives a wide range of input voltages and provides power suitable for powering any of a range of transceivers.

In some embodiments, a battery, optionally a rechargeable battery, is packaged in the connector assembly. In some embodiment the rechargeable battery is recharged by a source of electric power which is described herein as powering the transceiver.

In some embodiments, an example embodiment of a connector assembly is described herein as providing power to additional connector assemblies electrically connected to it, for example a mating connector, or a junction box, or via a junction box. A battery as described above may optionally provide power to such additional connector assemblies even when the cable upon which the connector assembly is constructed is receiving power. Such a battery enables the connector assembly to continue powering other connector assemblies through power outages, or even if the cable upon which the connector assembly is constructed is cut somewhere along the cable.

Cable to Cable Connections

An aspect of some embodiments relates to providing fiber-optic-cable to fiber-optic-cable connectors, which can potentially be connected and disconnected in dirty conditions.

In some embodiments the connectors include transceivers, which transform optic signals to electric signals, and the connectors expose a face with electric contacts, while keeping the optic fibers sealed.

In some embodiments, electric power for the transceivers is provided over at least one of the cables, by using a cable with both an optic fiber and an electric conductor. In some embodiments, both cables are cables with both an optic fiber and an electric conductor. In some embodiments, one cable is a cable with both an optic fiber and an electric conductor, another cable is a cable without an electric conductor, and power for a transceiver in the electric-conductor-less cable is optionally provided by one or more electric contacts in the connector faces, from the connector which has power brought to it through its cable, to the connector which does not.

Cable to Wall Connections

An aspect of some embodiments relates to providing a wall connector for connecting a fiber-optic-cable to the connector mounted on or through a wall of a vehicle, vessel, installation or electronics box, which can potentially be connected and disconnected in dirty conditions.

Such wall connectors may be used to connect a fiber-optic-cable passing through a dirty environment to instruments behind the wall. On the wall is mounted a connector, which mates with the fiber-optic-cable, and transfers signals to and/or from the fiber-optic-cable to and/or from devices attached to the wall connector.

In some embodiments the fiber-optic-cable connector and the wall connector both include transceivers, which transform optic signals to electric signals, and the connectors expose a face with electric contacts.

In some embodiments, electric power for the transceivers is provided from the wall connector, by providing one or more electric contacts connected to a power source. The power source optionally provides power through the electric contact to a transceiver inside the fiber-optic-cable connector.

In some embodiments, electric power for at least the transceiver inside the fiber-optic-cable connector is provided over the fiber-optic-cable, by using a cable with both an optic fiber and an electric conductor.

In some embodiments the wall connector also includes a transceiver for transforming signals back from electric to optic fiber, and optic fiber carries the signals on into the vehicle, vessel, installation or electronics box. In some embodiments, electric power for at the transceiver inside the wall connector is provided over the fiber-optic-cable, by using a cable with both an optic fiber and an electric conductor.

Cable to Connector Seal

An aspect of some embodiments relates to providing a fiber-optic-cable sealed under clean conditions to a connector constructed as taught herein, so that the fiber optic end is not exposed to dirty conditions.

In some embodiments such a product may include a length of fiber optic cable, with or without an accompanying electric conductor, and at least one end of the cable connected to and sealed to a connector constructed as taught herein.

Connector Kit

An aspect of some embodiments relates to providing a kit including a connector for a fiber-optic-cable constructed as taught herein, plus a sealing adapter, so that a client may assemble, under clean conditions, a fiber optic cable, with or without an accompanying electric conductor, to the connector, and produce a fiber-optic-cable plus connector assembly which has electric rather than optic contacts, which can potentially be connected/disconnected under dirty conditions without exposing the optic fiber end to the dirty conditions.

In some embodiments the sealing adapter seals well enough for many uses, which in some embodiments, such as for high-pressure and/or undersea use, after connecting the fiber optic cable to the connector, a potting material may additionally be used to better the sealing of the adapter and the connector.

Connection to Unaltered Connectors

An aspect of some embodiments relates to providing connector assemblies according to example embodiments of the invention, which are able to connect to unaltered connectors which are not constructed according to example embodiments of the invention. The optic signals are converted to electric signals, and a connector assembly according to example embodiments of the invention may connect to an electrical connector. Powering a transceiver within a connector assembly constructed according to example embodiments of the invention may be done (a) through a power conductor entering the connector assembly via a back of the connector assembly; (b) through a contact providing power already present in an unaltered connector which is not constructed according to example embodiments of the invention; and (c) by a battery optionally included within the connector assembly.

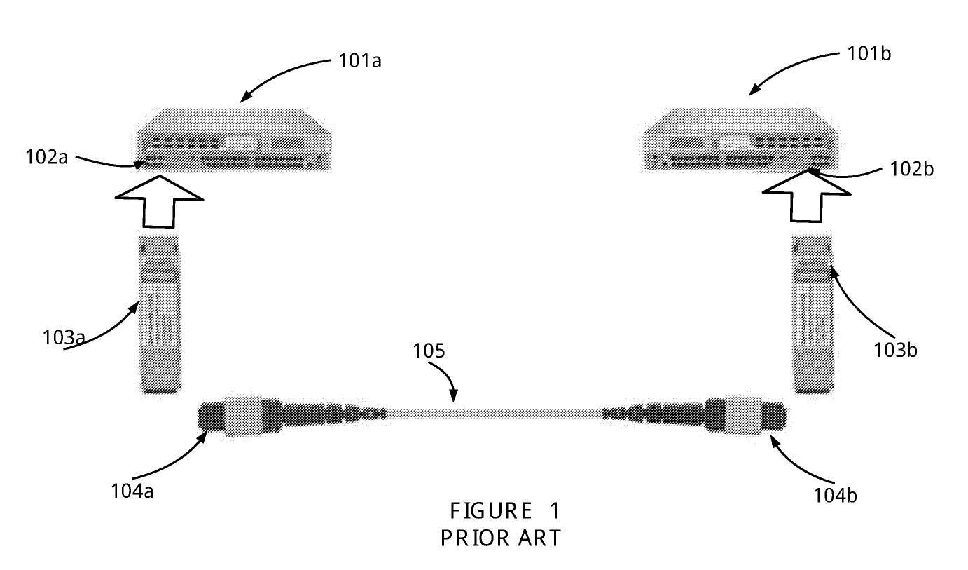

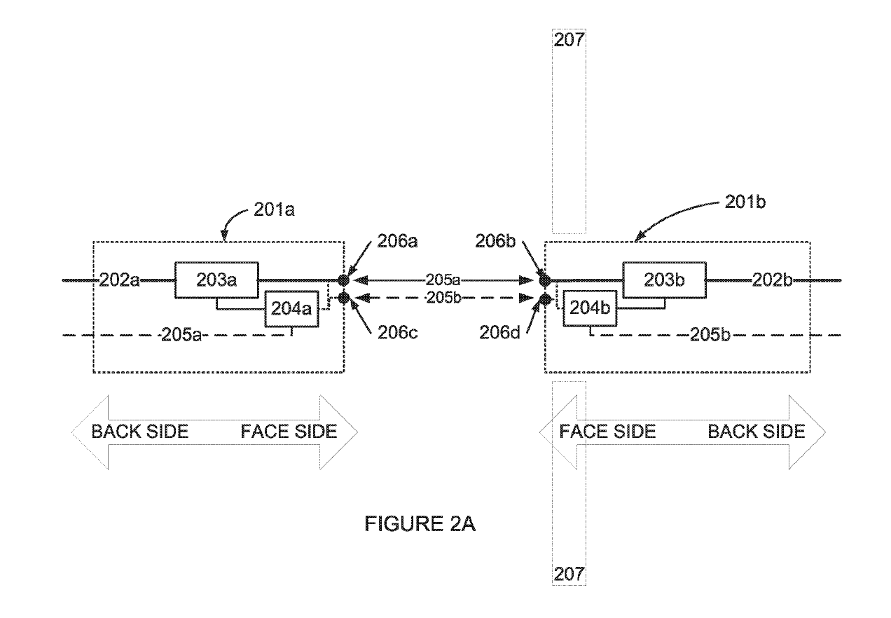

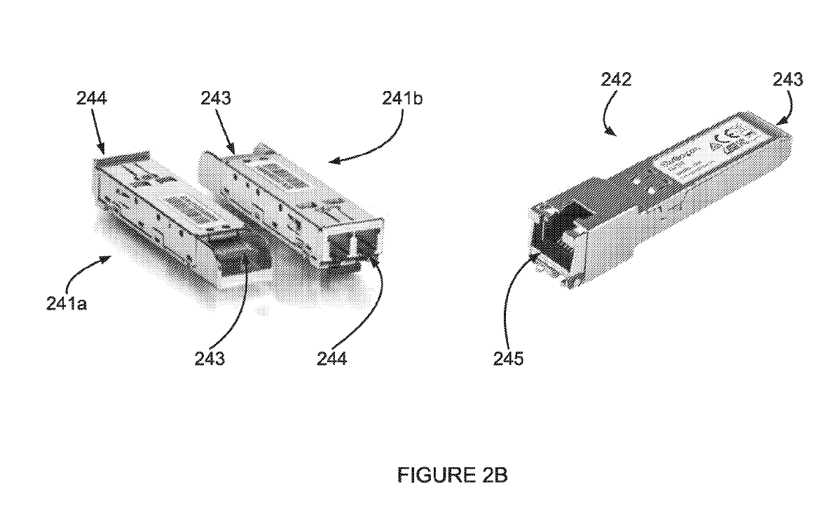

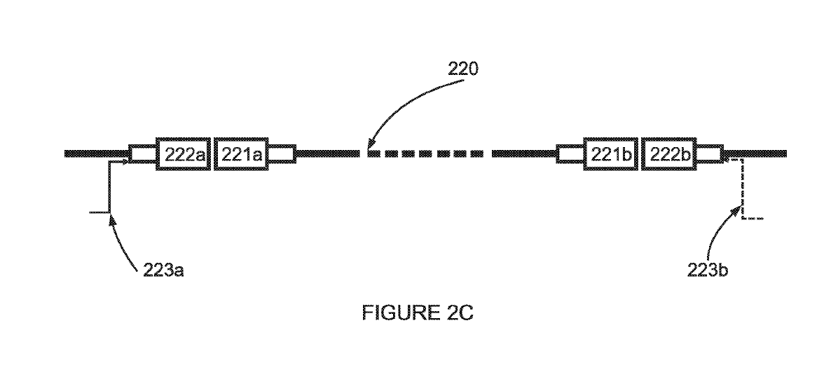

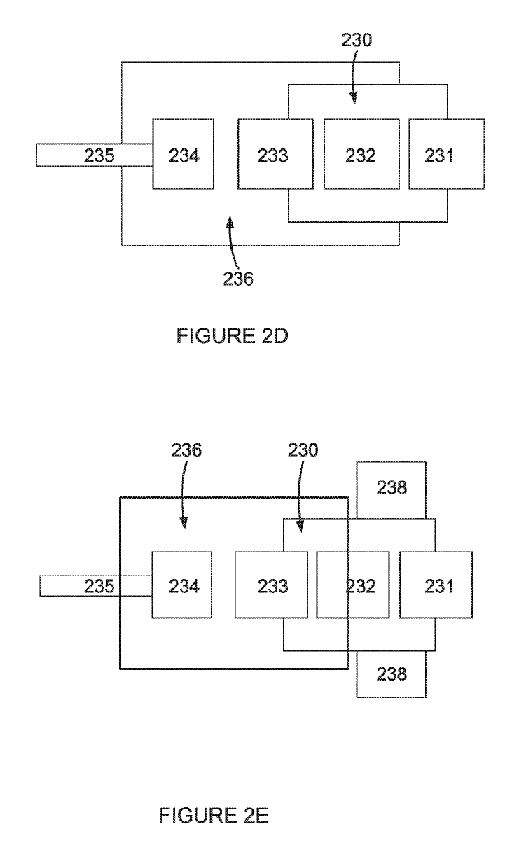

For purposes of better understanding some embodiments of the present invention, as illustrated in FIGS. 2A-E, 3A-E, 4A, 5, 6A-D, 7, 8A-B, 9 and 10 of the drawings, reference is first made to FIG. 1, which is a simplified illustration of a prior art method of using fiber optic cable for carrying signals.

FIG. 1 depicts junction boxes 101a 101b at two locations. The junction boxes 101a 101b include optic-to-electric transceivers 103a 103b which are actually packaged inside the junction boxes, exposing optic connectors 102a 102b. The transceivers 103a 103b are powered by the junction boxes 101a 101b. An optic cable 105 having appropriate optic connectors 104a 104b may serve to connect the two junction boxes 101a 101b, by inserting the optic connectors 104a 104b into the optic connectors 102a 102b of the transceivers 103a 103b of the junction boxes 101a 101b.

Since an optic to optic connection is made at an exposed side of the transceivers and a non-rugged copper to copper connection is made inside the junction boxes, the junction boxes 101a 101b and the cable 105 of FIG. 1 are suitable for use in reasonably clean conditions, as may be expected to exist in laboratories, homes, offices, and so on.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIG. 2A, which is a simplified block diagram illustration of a fiber optic cable connector for a rugged environment constructed according to an example embodiment of the invention.

FIG. 2A depicts two connector assemblies 201a 201b facing each other, in a configuration where electric contacts, optionally metal contacts, face mating electric contacts.

Arrows depict ‘back side’ and ‘face side’ directions with respect to the connectors of FIG. 2A. These directions apply to connector assemblies and connections in other drawings in the present application. The term ‘face side’ is used for a side of a connector assembly with an electric interface, used for mating with an associated mating connector, and the term ‘back side’ is used for an opposite side of the connector assembly.

The term “shell” in all its grammatical forms is used throughout the present specification and claims to mean a rigid component for mating and creating a physical interface and/or a contact, to a mating shell or to a similar structure designed for making the physical interface and/or contact.

The term “connector assembly” in all its grammatical forms is used throughout the present specification and claims to mean an entire connector unit, which may include a shell, and may include a shell plus additional sheathing.

Fiber optic cables 202a 202b enter from back sides of the connector assemblies 201a 201b, and connect to optic signal ends of transceivers 203a 203b. Electric signal ends of the transceivers 203a 203b are electrically connected to one or more electric contact(s) 206a 206b on face sides of the connector assemblies 201a 201b.

It is noted that one or more electric connectors 206a 206b 206c 206d may be used to transfer electric signals from one of the connector assemblies 201a 201b to the other.

When the connector assemblies 201a 201b are connected face-to-face, one or more electric contact(s) are made, and an optic signal passed into a first one of the connector assemblies 201a 201b is translated into an electric signal, transmitted as an electric signal to the second one of the connector assemblies 201a 201b, translated into an optic signal, which can pass out of the second one of the connector assemblies 201a 201b.

The connector assemblies 201a 201b include power converters 204a 204b which provide electric power to the transceivers 203a 203b.

The power converters 204a 204b themselves receive power from a source of electric power, e.g. voltage, Alternating Current (AC) or Direct Current (DC), and optionally transform the electric power into a correct form, suitable for powering the transceivers 203a 203b.

The power converters 204a 204b in the example embodiment described with respect to FIG. 2A, as well as with respect to example embodiments described later on, may accept power as follows:

An AC frequency 50 Hz/60 Hz/400 Hz from 5V up to 250V.

A DC voltage range from 2V to 60V.

In some embodiments, power to the power converter 204a 204b may be supplied via an optional electric conductor 205a 205b entering from a back of the connector assemblies 201a 201b. In some embodiments, the electric conductor 205a 205b may optionally be packaged with the optic fiber 202a 202b in the same cable.

In some embodiments, power to the power converter 204a 204b may be supplied via an optional electric contact 206a 206b on a face side of the connector assemblies 201a 201b.

It is noted that one or more electric connectors 206a 206b 206c 206d may be used to transfer electric power from one of the connector assemblies 201a 201b to the other.

It is noted that the electric connector(s) used to transfer electric power may or may not be the same connectors used for transferring signals from one of the connector assemblies 201a 201b to the other. Sharing an electric connector for both power and signal transfer may be done as is known in the art.

In some embodiments, in a cable to cable connection, a first one of the connector assemblies 201a 201b may be powered from a back side, via an optic-plus-electric-conductor cable, and provide power to a second one of the connector assemblies 201a 201b through an electric contact on a face side.

In some embodiments, in a cable to wall connection, one of the connector assemblies 201a may be a cable ending, and another of the connector assemblies 201b may optionally be a connector passing through a wall 207. The connector assembly 201b may be powered, and provide power to the cable-ending connector assembly 201a through an electric contact on a face side of the wall connector.

A person skilled in the art will appreciate that transceivers exist for both optic-to-electric signal conversion, and for electric-to-electric signal conversion.

Various embodiments of the invention are described herein with reference to face-side electrical contacts which enable dirty connect/disconnect operations on a fiber-optic cable. However, a person skilled in the art will appreciate that various types of electric signal cables are also unsuited for dirty connect/disconnect operations, and can benefit from being packaged in connector assemblies which include transceivers so that the electric signals are in a form suitable to connect to mating connectors.

Reference is now made to FIG. 2B, which is a simplified illustration of transceivers for use in an example embodiment of the invention.

FIG. 2B depicts two views 241a 241b of an optic-to-electric transceiver.

A first view 241a of the optic-to-electric transceiver depicts a side of the optic-to-electric transceiver which includes an electric signal interface 243 suitable for interfacing with, by way of a non-limiting example, an electrical socket, for example in a switch board. The optic-to-electric transceiver has an optic fiber interface 244 on its other side, so the optic fiber interface 244 is not visible in the first view 241a.

A second view 241b of the optic-to-electric transceiver depicts a side of the optic-to-electric transceiver that includes the optic fiber interface 244, and the electric signal interface 244 is also visible on the other side of the optic-to-electric transceiver.

The optic-to-electric transceiver depicted in FIG. 2B is a Small Form-factor Pluggable (SFP) transceiver.

FIG. 2B also depicts an electric-to-electric transceiver 242.

The electric-to-electric transceiver 242 an electric signal interface 243 suitable for interfacing with, by way of a non-limiting example, a network cable, for example an RJ-45 interface. The electric-to-electric transceiver 242 also has an electric interface 243 on its other side, but the electric interface 243 is not visible.

The electric-to-electric transceiver 242 depicted in FIG. 2B is also a SFP transceiver.

Persons skilled in the art will appreciate that wherever in the present application an optic-to-electric transceiver is mentioned, an electric-to-electric transceiver may be used. Specifically, in descriptions of powering a transceiver, the electric-to-electric transceiver may receive it power similarly to the optic-to-electric transceiver, and in descriptions of an optic cable with or without and associated electric conductor, and electric cable may be understood, with or without an associated additional conductor line for carrying electric power. In some embodiments, when an electric cable is used, the electric cable may optionally provide power over a same conductor as the electric cable provides a signal.

Reference is now made to FIG. 2C, which is a simplified illustration of a fiber optic cable 220 constructed according to an example embodiment of the invention.

FIG. 2C depicts the fiber optic cable 220 having connectors 221a 221b at both of its ends, the connectors 221a 221b constructed according to an example embodiment of the invention.

The connectors 221a 221b may be connected/disconnected in a dirty environment, having electric contacts, optionally electric contacts designed for dirty connection/disconnection.

The fiber optic cable 220 is connected at its ends to other connectors 222a 222b which belong to other systems, whether junction boxes, additional cables, or electronic devices which use the fiber optic cable 220 for data transfer.

Both of the ‘other’ connectors 222a 222b may be part of systems (not shown) which can provide power 223a 223b to transceivers in the connectors. In such a case the transceivers in the cable-end connectors 221a 221b may be powered through power-providing contacts at the connector assembly faces such as described above with reference to FIG. 2A.

Only one of the ‘other’ connectors 222a 222b may be part of a system (not shown) which can provide power 223a 223b to transceivers in the connectors. In such a case one of the transceivers in the cable-end connectors 221a 221b may be powered through a power-providing contact at the connector assembly faces such as described above with reference to FIG. 2A, and the cable 220 may optionally include an electric conductor to provide power from a first end of the cable connected to a powered connector, to a connector at the second end of the cable, and through that connector to its mating connector.

It is noted that the cable end connectors 221a 221b in FIG. 2C optionally include transceivers, environmental seals, and may optionally include power converter circuits to translate provided electric power to electric power suitable for the transceivers.

It is noted that the connectors 222a 222b facing the cable end connectors 221a 221b in FIG. 2C may optionally include transceivers (if their systems use optic fiber connections rather than electric connections), include environmental seals, and may optionally include power converter circuits if transceivers are included.

Reference is now made to FIG. 2D, which is a simplified block diagram illustration of components in an example embodiment of the invention.

FIG. 2D describes the example embodiment in functional terms. FIG. 2D depicts a connector shell 230, with which are packaged an external interface 231, an internal interface 232, and a transceiver 233. An optic cable 235 having an optic connector 234 is attached to an optic end of the transceiver 233. The connector shell 230 is surrounded by an enclosure 236, which seals the connector shell 230 and components against the environment, exposes electric contacts (not shown) on a front face of the external interface 231, and enables the optic cable 235 to exit from a back end of the enclosure 236 without breaking the seal.

Reference is now made to FIG. 2E, which is a simplified block diagram illustration of components in an example embodiment of the invention implemented as a wall mount.

FIG. 2E again describes the example embodiment in functional terms. FIG. 2E depicts a connector shell 230, with which are packaged an external interface 231, an internal interface 232, and a transceiver 233.

The connector shell 230 is depicted as penetrating through a wall 238.

FIG. 2E also depicts an optic cable 235 having an optic connector 234 is attached to an optic end of the transceiver 233. The connector shell 230 is surrounded by an enclosure 236, which seals the connector shell 230 and components against the environment, exposes electric contacts (not shown) on a front face of the eternal interface 231, and enables the optic cable 235 to exit from a back end of the enclosure 236 without breaking the seal. In some embodiments, the enclosure 236 is not used, if the side of the wall 238 is in a reasonably clean environment.

Some of the functional components mentioned above will now be described in more detail below.

The external interface 231 is a front face of the connector shell 230, which may optionally be exposed to a harsh environment. The external interface 231 may also include a front gasket, for sealing, which during an interfacing of two connectors, potentially pushes out moist and dirt during a mating process; and electric contacts penetrating through the front gasket.

In some embodiments, the contacts of the external interface 231 are optionally placed at a distance from each other so as to match an impedance of a standard transceiver contact impedance, in order to maintain signal integrity, especially at high data transfer rates. Impedance between two parallel conductors is optionally calculated using the following formula:

Z=[Z₀ a cos h(D/d)]/[π·√εᵣ] Equation 1

where Z₀ is impedance of free space (˜376.7 Ohms), D is an axis to axis distance between two adjacent conductors, d is a diameter of the conductor, and εᵣ is a relative permittivity of an insulating material between the conductors.

The relative permittivity εᵣ depends on the insulating material. Optionally a frequency stable material such as Teflon or a glass filled epoxy is used, with relative permittivity=2 and 5 respectively. It is also convenient to have the contacts within reasonable distance of each other (D=1 to 5 mm), which provides good geometric layouts in terms of contact density and spacing for insulation. A typical contact diameter can be in a range of 0.3 to 1.5 mm. A proper combination of the ranges above can be selected to achieve a target impedance. For example, contacts interfacing a small-form plug transceiver may optionally have approximately 100-ohm.

The internal interface 232 may also include a power converter; and/or an electro-mechanical attachment for a transceiver 233 to electrically connect to the electric contacts of the external interface 231. The electro-mechanical attachment may include a transceiver cage. The electro-mechanical attachment may be in a form of a Printed Circuit Board (PCB), optionally with a transceiver cage and/or a power converter attached.

The connector shell 230 is optionally a component which houses the other components. In some embodiments the connector shell 230 connects components together, although not necessarily within the connector shell 230, optionally having a component such as the enclosure 236 enveloping and sealing the components and the connector shell 230 together. An example embodiment of the connector shell 230 may have a diameter in a range of 10, 20, 30, 40 and 50 mm, and a length of 10, 20, 30, 40, 50, 60 and 70 mm.

A Fiber Optic Transceiver Module (transceiver) is a component that can both transmit and receive, transforming electric signals to optic signals, and optic signals to electric signals. Usually, the transceiver is inserted in devices such as routers or network interface cards which provide one or more transceiver module slots, such as CBIC (GigaBit Interface Converter), SFP (Small Form-factor Pluggable), SFP+ (advanced Small Form-factor Pluggable), XFP (10 Gigabit Small Form-Factor Pluggable), QSFP (Quad Small Form-factor Pluggable), QSFP+ (advanced Quad Small Form-factor Pluggable), CSFP (Compact Small Form-factor Pluggable), CFP (C Form-factor Pluggable), and CXP (advanced C form-factor pluggable).

The transceiver 233 may optionally be a small form factor transceiver, preferably a standard transceiver, such as, by way of some none limiting examples, SFP (Small Form-factor Pluggable), SFP+, XFP, QSFP, QSFP+, CSFP, CFP, X2, XENPAK, XFI, CXP, digital video SFP, GBIC, MGBIC. An interface of the transceiver 233 to fiber optic may be any standard fiber optic interface, such as, by way of some non-limiting examples, LC (“Lucent Connector” or “Little Connector”, or “Local Connector”), LC duplex (two “Lucent Connectors”), SC (“Subscriber Connector” or “square connector” or “Standard Connector”), FC (“Ferrule Connector” or “Fiber Channel”), MPO (Multiple-Fiber Push-On), MTP (Multiple-Fiber Pull-off), SMA (Sub Miniature A), SMC (Sub Miniature C), ST (Straight Tip), and BFOC (Bayonet Fiber Optic Connector).

An interface of an electric signal side of the transceiver 233 to electrical may optionally be wires attached to the electro-mechanical attachment, or, by way of some non-limiting examples, an RJ-45 connector, RS-232, Co-ax, USB and HDMI.

The optional enclosure 236, or sheath, may optionally be part of an assembled connector, or provided as a separate adapter component. Components within the sheath may be potted, optionally using the adapter as a mold for a potting material such as a resin, epoxy, or polyurethane. In some embodiments the enclosure 236 may be formed of a potting material with our without an additional outer casing or sheath. An example embodiment of the optional enclosure 236, or sheath, may have a diameter in a range of 10, 20, 30, 40, 50, 60, 70 and up to 100 mm and above, and a length of 10, 20, 30, 40, 50, 60, 70, 80, 90, 100, 110 120, 130, 140, 150, and up to 200 mm ad above.

The data cable 235 may optionally include one or more optic fibers and/or optic connectors. The data cable 235 may also optionally include one or more electric conductors, and/or wired network wire(s), and or an electric or a network connector such as an RJ-45 connector.

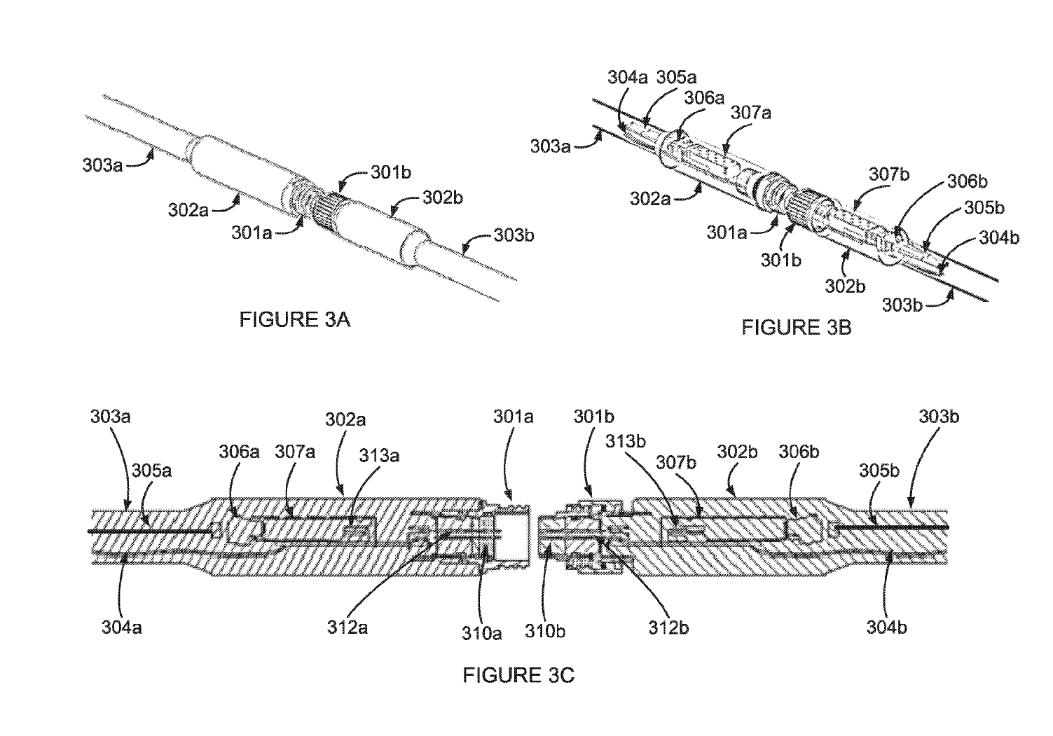

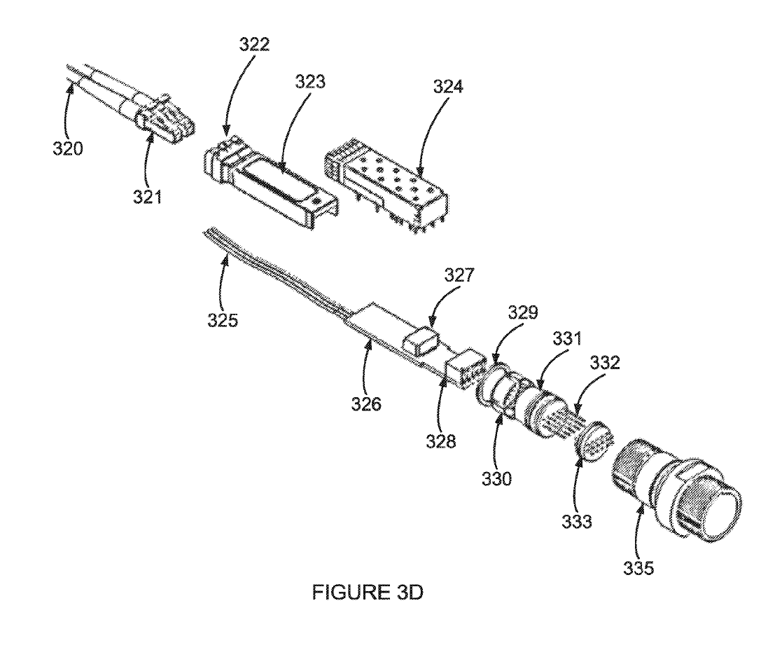

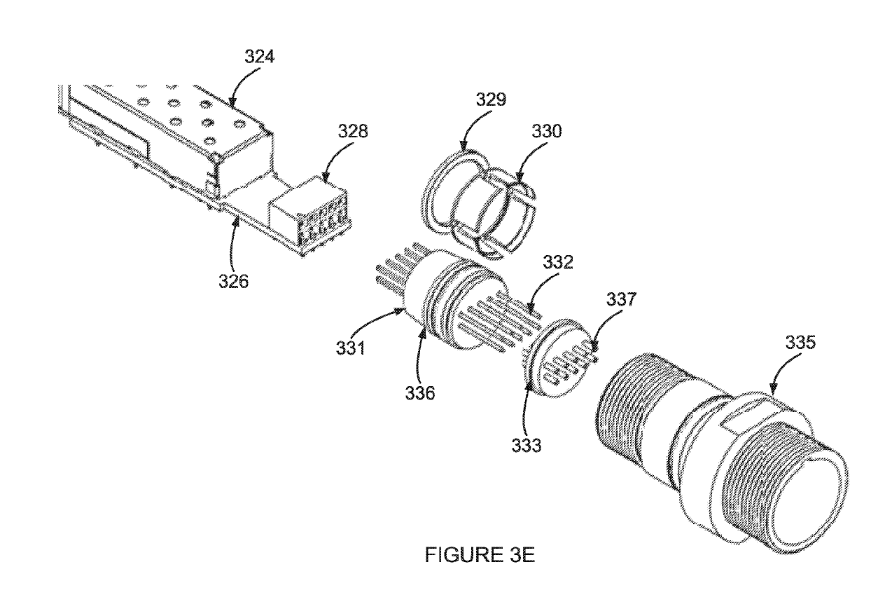

Reference is now made to FIGS. 3A-C, which are simplified illustrations of fiber optic cable connectors for a rugged environment constructed according to an example embodiment of the invention.

FIGS. 3A-C depict an example embodiment of the invention in more detail than FIG. 2A.

FIG. 3A is an isometric illustration, FIG. 3B is a cross-sectional isometric illustration, and FIG. 3C is a cross-sectional side view illustration, of a fiber optic cable 303a,b, a connector assembly 302a,b and connection components 301a,b.

FIGS. 3A-C also depict:

an optional electric conductor 304a,b in the optic fiber cable 303a,b;

an optic fiber 305a,b in the optic fiber cable 303a,b;

a transceiver 307a,b, with an optic fiber socket 306a,b;

an optional power converter unit 313a,b;

one or more contact(s) 312a,b making an electric connection from the electric side of the transceiver 307a,b and/or the optional power converter unit 313a,b to a face side of the connector assembly 302a,b; and

environmental protection gasket 310a,b for sealing the connector assembly 302a,b, optionally sealing one or more passageways for the one or more contact(s) 312a,b through the environmental protection gasket 310a,b.

In some embodiments the connector assembly 302a,b may be filled with potting or sealing material.

In some embodiments the connector assembly 302a,b may be surrounded by potting or sealing material.

In some embodiments the power converter unit 313a,b may include a battery, optionally a rechargeable battery.

Reference is now made to FIG. 3D, which is a simplified illustration of an exploded view of an example embodiment of the invention.

FIG. 3D depicts the example embodiment in even more detail than above, and depicts additional optional components for environmental protection.

FIG. 3D depicts components packaged within a connector assembly (not shown):

optic fiber(s) 320, optionally having a standard connector 321;

a transceiver 323 with an optic fiber socket 322 for connection to the connector 321;

an optional cage 324 for mechanically and/or electrically shielding and/or supporting the transceiver 323;

an optional electric conductor 325, which may or may not be part of a cable containing the optic fiber(s) 320;

an optional mount 326 for optionally mounting the transceiver 323, and for optionally mounting an optional power converter 327;

an optional connector 328 for making electric connections from the transceiver 323;

an optional retainer 329, support 330, and insert 331 for withstanding high pressure, optionally as described in above-mentioned co-filed U.S. Provisional Patent Application titled “CONNECTOR FOR WITHSTANDING HIGH PRESSURE” (Attorney Docket No. 65411) by Moshe BAR-HAI et al.;

one or more electric contacts 332, for connecting to conductors (not shown) in a mating connector (not shown);

a sealing gasket 333 for environmental sealing of the above-listed components; and

a connector component 335 for connecting to a corresponding fiber optic cable connector, or to a wall connector, as described elsewhere herein.

In some embodiments the power converter 327 may include a battery, optionally a rechargeable battery.

Reference is now made to FIG. 3E, which is a simplified illustration of the example embodiment of FIG. 3D.

FIG. 3E depicts the example embodiment in a larger, and unexploded view of a portion of FIG. 3D, concentrating on environmental protection and optional high pressure handling of the design.

FIG. 3E depicts:

the transceiver cage 324 mounted to the mount 326, obstructing view of the optional power converter and the transceiver;

the optional connector 328;

the optional retainer 329, support 330, and insert 331 for withstanding high pressure, optionally as described in above-mentioned co-filed U.S. Provisional Patent Application titled “CONNECTOR FOR WITHSTANDING HIGH PRESSURE” (Attorney Docket No. 65411) by Moshe BAR-HAI et al;

the contacts 332;

the sealing gasket 333, with optional sealing tubes 337 for sealing against each one of the contacts 332; and

the connector component 335 for connecting to a corresponding fiber optic cable connector, or to a wall connector, as described elsewhere herein.

In some embodiments the support 330 and the insert 331 are shaped so that when a face of the insert 331 is under pressure, the force of the pressure is re-directed by the insert and the support 330 against the connector component 335 in a direction which reduces shear, and potentially compresses the insert 331 onto the contacts 332, enhancing structural and/or electric integrity of the connection instead of compromising the structural and/or electric integrity of the connection.

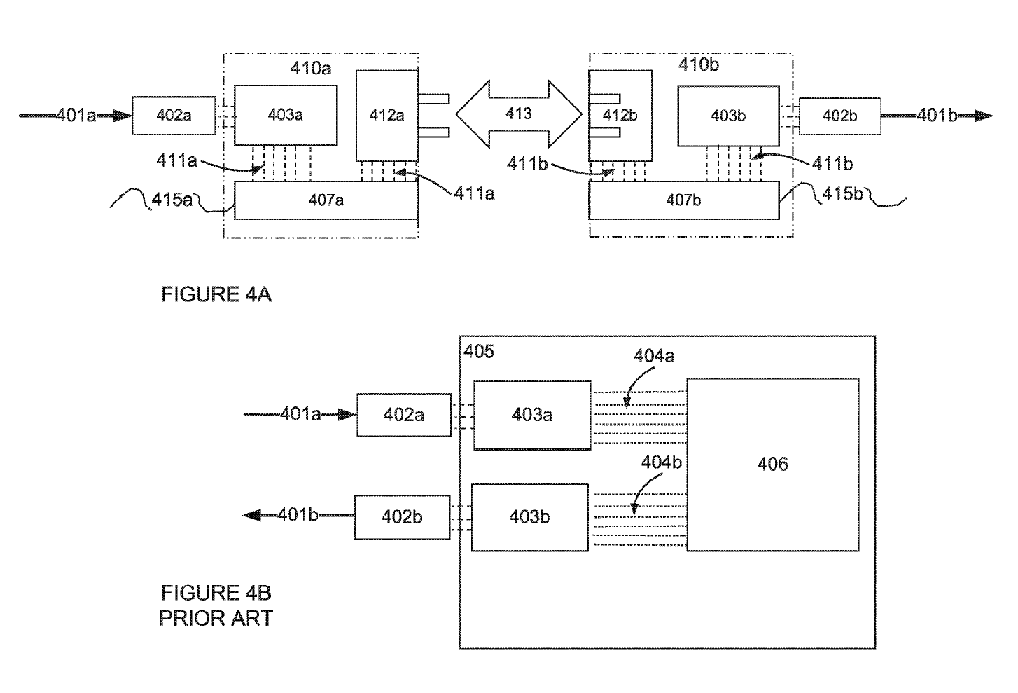

Reference is now made to FIGS. 4A and 4B, of which FIG. 4A depicts an example embodiment of the invention, in contrast with FIG. 4B, which depicts a prior art embodiment.

FIGS. 4A and 4B are intended to emphasize some differences between the example embodiment of FIG. 4A and a prior art embodiment of FIG. 4B.

FIG. 4B depicts an embodiment similar to that drawn in FIG. 1—a data signal 401a is conveyed by a fiber optic cable line 402a to a transceiver 403a, which translates the data signal 401a to an electric signal which is conveyed by electrical connections 404a to an interface circuit 406 in a switch board 405. The interface circuit 406 may cause the data signal to be routed via electrical connections 404b to a transceiver 403b, which translates the electric signals into optic signals 401b which are conveyed by a fiber optic cable line 402b.

That is a prior art implementation of connecting one fiber optic cable line 402a to another fiber optic cable line 402b. However, it is noted that the fiber optic cable lines 402a 402b connect/disconnect from the transceivers, and the connect/disconnect must be done in a clean environment.

FIG. 4A depicts an embodiment similar to that drawn in FIGS. 2A and 3A-C. FIG. 4A depicts a data signal 401 conveyed by a fiber optic cable line 402a transmitted to another fiber optic cable line 402b without requiring a switchboard 405 or an interface circuit 406.

FIG. 4A depicts a data signal 401 conveyed by a fiber optic cable line 402a entering a transceiver 403a packaged in a connector assembly 410a. The transceiver 403a translates the data signal 401 to an electric signal, which passes over electrical connections 411a to metal connector(s) 412a on a face of the connector assembly 410a. The electric signal continues via a physical interface 413 to a mating connector assembly 410b. In the mating connector assembly 410b the electric signal continues over electrical connections 411b to a transceiver 403b packaged in the mating connector assembly 410b. the transceiver 403b translates the electric signal into an electric signal 401b carried by the fiber optic cable line 402b.

In some embodiments one or both of the connector assemblies 410a 410b may include an optional transceiver power converter 407a 407b and an electrical conductor(s) 415a 415b for powering the optional transceiver power converter 407a 407b.

The embodiment of FIG. 4A depicts a potential optic-fiber-cable to optic-fiber-c able connection. However, the embodiment of FIG. 4A also supports an optic-fiber-cable to optic-fiber-cable connection made through a wall, where one of the connectors passes through the wall. The embodiment of FIG. 4A also supports an optic-fiber-cable to optic-fiber-cable connection made through a junction box, where the junction box does not require an interface circuit 406, and where the transceivers are part of the connectors, not part of the junction box.

Example embodiments of the invention do not require passing though a “protocol IC”, rather directly connect two transceivers. The direct connection may require a power converter from at least one side of a connection assembly.

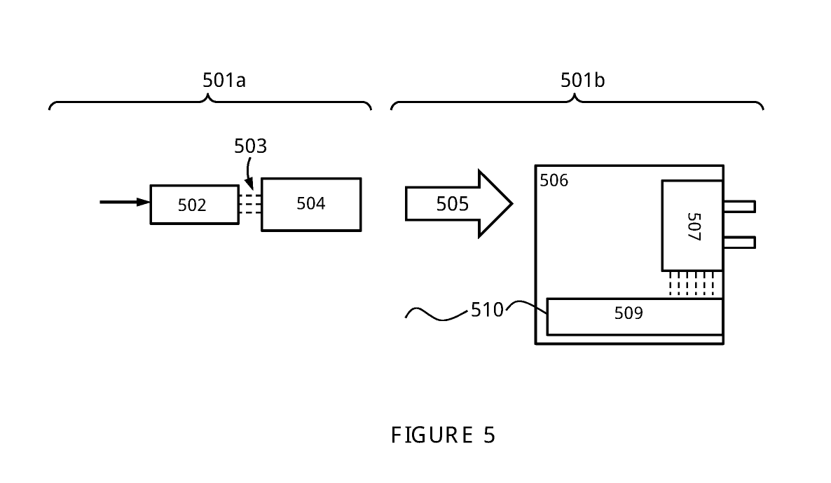

Reference is now made to FIG. 5, which is a simplified illustration of an example embodiment of the invention.

FIG. 5 depicts the example embodiments as two components: a first component 501a including a transceiver 504 (optionally an industry standard transceiver) and a cable 502, and second component 501b including an interface unit built into a connector assembly 506 constructed according to an embodiment of the design taught herein. The connector assembly 506 potentially surrounds and protects the transceiver 504. Contact(s) 507 on an external face of a connector portion of the connector assembly 506 potentially enable extreme environmental durability, thus potentially enabling optic fiber transfer rates with durability of an out-door copper-to-copper connection.

FIG. 5 depicts the first components 501 including the cable 502 inserted 503 into the transceiver 504. The first component is inserted into the connector assembly 506, making electrical contact with a transceiver power converter 509, and with metal contact(s) 507 on a face of the connector assembly 506.

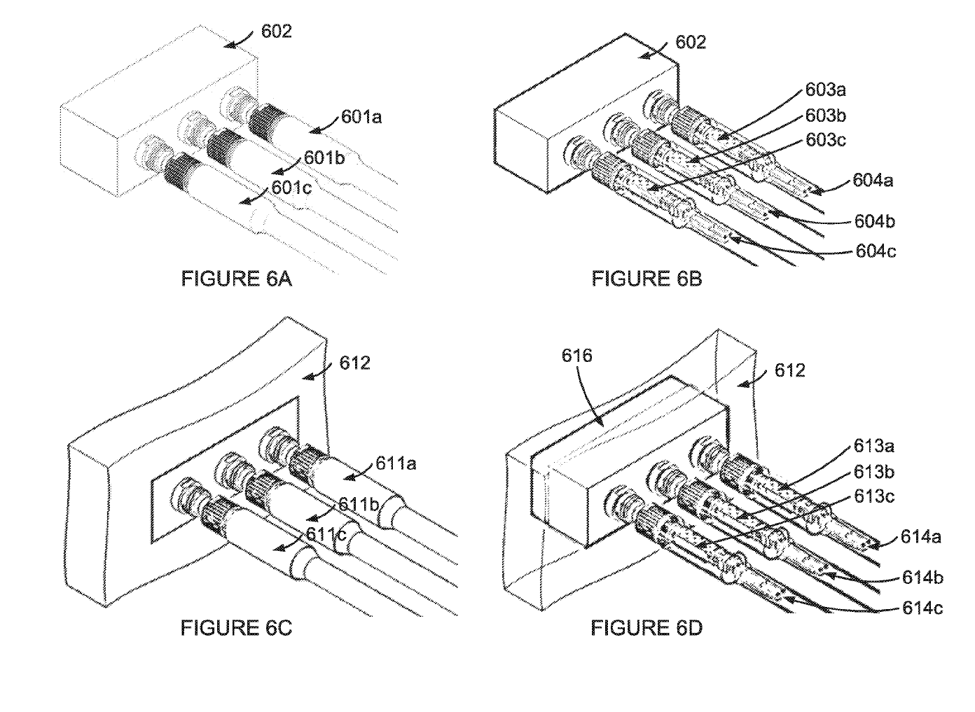

Reference is now made to FIGS. 6A and 6B, which are simplified illustrations of connectors 601a,b,c connected to connectors in a junction box 602 according to an example embodiment of the invention.

FIG. 6A depicts an isometric drawing of the connectors 601a,b,c connected to the junction box 602, and FIG. 6B depicts a view inside the connectors 601a,b,c.

FIG. 6B also depicts transceivers 603a,b,c, optionally with industry standard connectors 604a,b,c for optical fiber connection, and in some embodiments, optionally with industry standard SFP interfaces on the other end of the transceiver.

If the junction box has a power source, then the transceivers 603a,b,c in the connectors 601a,b,c may optionally be connected to the power source, or power converter components within the connectors 601a,b,c optionally be connected to the power source and provide power to the transceivers 603a,b,c.

If the junction box does not have a power source, then one or more of the transceivers 603a,b,c in the connectors 601a,b,c may optionally be connected to electric conductors in the optic cables, as described elsewhere herein, and the cables with the electric conductor may also provide power to the transceivers of the connectors 601a,b,c through contacts in the connector faces, as described elsewhere herein. It is noted that any one of the powered connectors can power the junction box, which in turn can power any non-powered connectors attached to it.

Reference is now made to FIGS. 6C and 6D, which are simplified illustrations of connectors 611a,b,c connected to a wall 612 according to an example embodiment of the invention.

FIG. 6C depicts an isometric drawing of the connectors 601a,b,c connected to connectors in a wall 612, and FIG. 6D depicts a view inside the connectors 601a,b,c.

FIG. 6D also depicts transceivers 613a,b,c, optionally with industry standard connectors 614a,b,c for optical fiber connection, and, not shown, optionally with an industry standard SFP interface on the other end of the transceivers 613a,b,c.

FIG. 6D also depicts that behind the wall 612 optionally might be a junction box 616, although other possibilities of uses for connectors going through a wall are contemplated, such as other electronic devices (not shown).

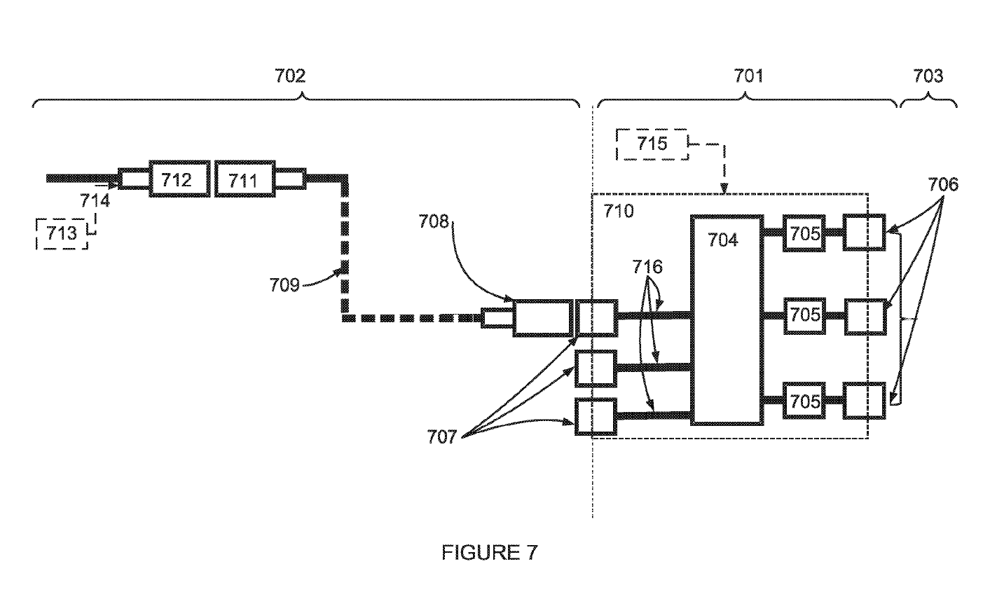

Reference is now made to FIG. 7, which is a simplified block diagram illustration of a junction box for cable connectors according to an example embodiment of the invention.

FIG. 7 depicts an optic cable 709 connected to a junction box 710.

The optic cable 709 is optionally in a ‘dirty’ zone 702. The junction box 710 has one or more environmentally sealed electric connectors 707 facing the ‘dirty’ zone, connected 716 to a switch 704 (or hub) 704. FIG. 7 depicts the junction box 710 is in a ‘clean’ zone, although the junction box 710 may also be in a ‘dirty’ zone, with its insides being ‘clean’ and sealed against the environment.

The connection of the optic cable 709 to the junction box 710 is by an environmentally protected cable connector 708, for example such as described with reference to FIGS. 2A-C, 3A-E, 4A, 5 and 6A-D above, connecting to the environmentally sealed electric connector 707 on the face of the junction box 710. Inside the junction box the electric connectors 707 may lead to the switch 704 (or hub) 704, and from the switch 704 may lead to client connections 706. In some embodiments the client connections are to optic fiber, and the electric signals may pass through optional electric to optic signal converters 705, optionally transceivers similar to those used in the connector 708.

In some embodiments the junction box 710 may be provided with electric power by a power supply 715 in the ‘clean’ zone 701, or even packaged in the junction box 710.

In some embodiments the junction box 710 may provide electric power to a transceiver in the connector 708 by one or more contact(s) in the electric connectors 707.

In some embodiments a far end of the optic cable 709 may include a connector 711 constructed according to an embodiment of the invention, including a transceiver within, and may be connected to a mating connector 712, also constructed according to an embodiment of the invention, and the mating connector 712 may provide electric power to the transceivers in the connectors 711 712 through a power supply 713 connected 714 to the mating connector 712. In some embodiments the optic cable 709 is an optic cable which includes an electric conductor, and one side of the optic cable 709 may power the other, that is, the power supply 713 may power some or all of the connectors 712 711 708 along the way, and optionally even the junction box 710, or the power supply 715 may power some or all of the connectors 708 711 712.

In some embodiments the electric connectors 707 extends into the junction box 710 and connect directly to the switch 704 (or hub) 704.

In some embodiments the electric connectors 707 connect to an electric conductor bridge that plugs directly 716 into the switch 704 (or hub) 704 from the internal part of wall. In some embodiments an exposed portion of 707 has matching interface and gasket to connect to the connector 708 to enable attaching and disconnecting in harsh environments.

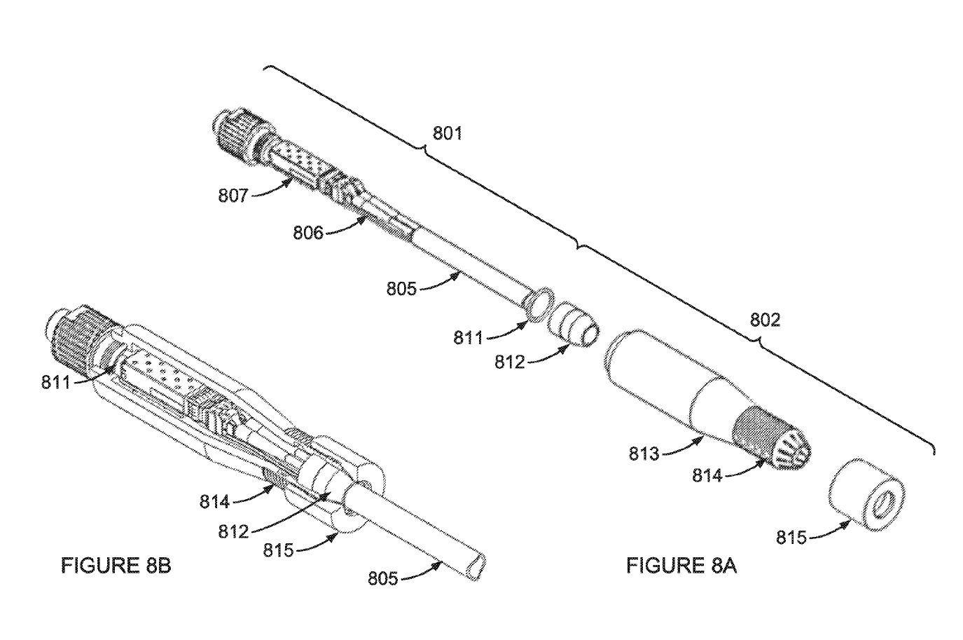

Reference is now made to FIGS. 8A and 8B, which are simplified illustrations of a kit for connecting an optic cable to a connector according to an example embodiment of the invention.

In some embodiments, an optic cable may be assembled into a connector constructed according to an example embodiment of the invention, sealed at an assembly plant under ‘clean’ conditions, and sold as an optic cable with a connector for use in a ‘dirty’ environment.

In some embodiments the connector may be sold without a cable, and an adapter be sold to enable a buyer to assemble an optic-cable-plus-electric-connector in a ‘clean’ environment, with the buyer's own optic cable, optionally making a decision on a desired length of cable and then performing the assembly.

FIG. 8A depicts such a connector 801 and adapter 802.

The connector 801 includes a transceiver 807 and additional components as described elsewhere herein, and optionally includes a fiber optic connector 806, preferably a standard fiber optic connector. A fiber optic cable 805 (not yet part of the connector 801) is depicted inserted into the fiber optic connector 806.

The adapter 802 includes components for sealing an optic cable 805 to a back end of the connector 801. The adapter 802 optionally includes an O-ring 811; a cable gasket 812, a sheath 813 optionally having a thread 814 along part of the sheath 813; and a nut 815 to thread on the sheath 813 and tighten a seal around the fiber optic cable 805.

FIG. 8A depicts an exploded view of the connector 801 and the adapter 802, and FIG. 8B depicts a cross-sectional view of the connector 801 and the fiber optic cable 805 assembled and sealed by the adapter 802.

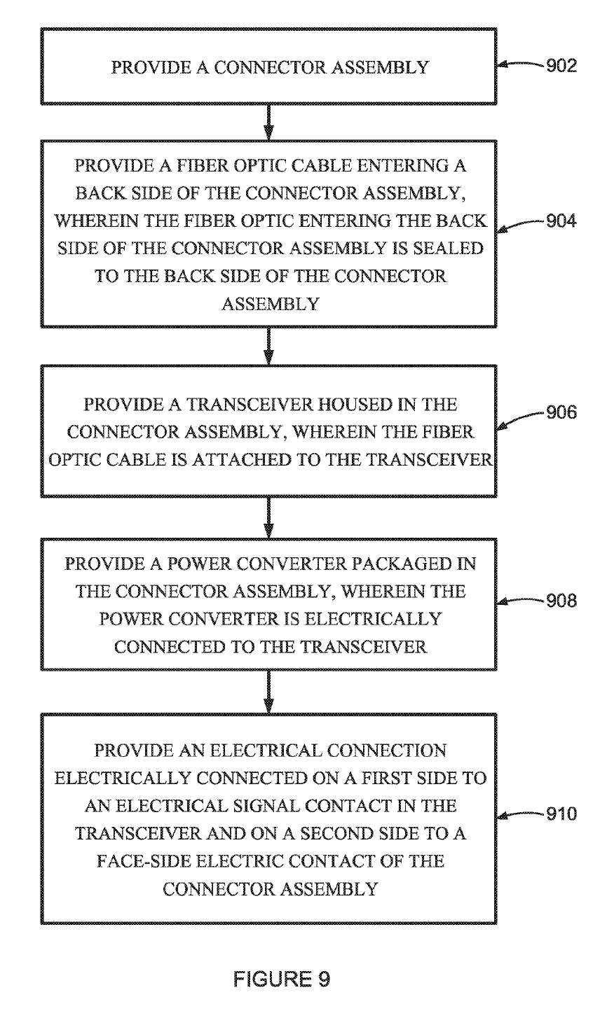

Reference is now made to FIG. 9, which is a simplified flow chart illustration of a method of providing a fiber optic cable with a connector for a rugged environment according to an example embodiment of the invention.

The method of FIG. 9 includes:

providing a connector assembly (902);

providing a fiber optic cable entering a back side of the connector assembly, wherein the fiber optic entering the back side of the connector assembly is sealed to the back side of the connector (904);

providing a transceiver housed in the connector assembly, wherein the fiber optic cable is attached to the transceiver (906);

providing a power converter packaged in the connector assembly, wherein the power converter is electrically connected to the transceiver (908); and

providing an electrical connection electrically connected on a first side to an electrical signal contact in the transceiver and on a second side to a face-side electric contact of the connector assembly (910).

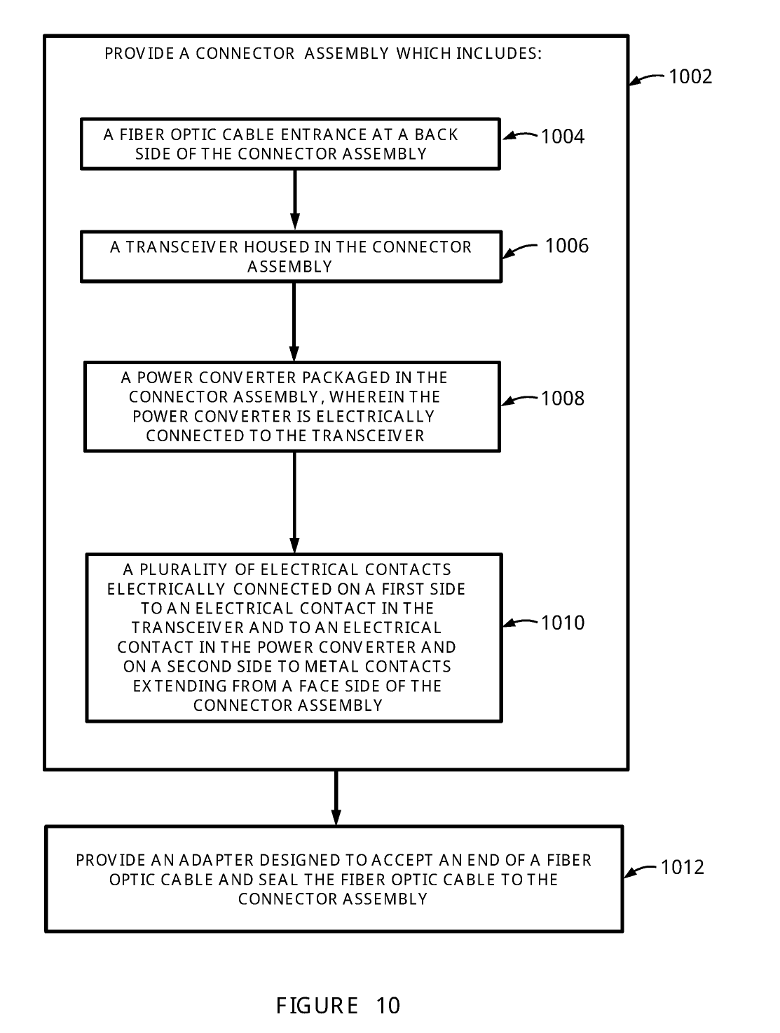

Reference is now made to FIG. 10, which is a simplified flow chart illustration of a method of providing a fiber optic connector kit for a rugged environment, according to an example embodiment of the invention.

The method of FIG. 10 includes:

providing a connector assembly (1002) which includes:
a fiber optic cable entrance at a back side of the connector assembly (1004);
a transceiver housed in the connector assembly (1006);
a power converter packaged in the connector assembly, wherein the power converter is electrically connected to the transceiver (1008); and
an electrical connection electrically connected on a first side to an electrical signal contact in the transceiver and on a second side to a metal contact on a face side of the connector assembly (1010); and

providing an adapter designed to accept an end of a fiber optic cable and seal the fiber optic cable to the connector assembly (1012).

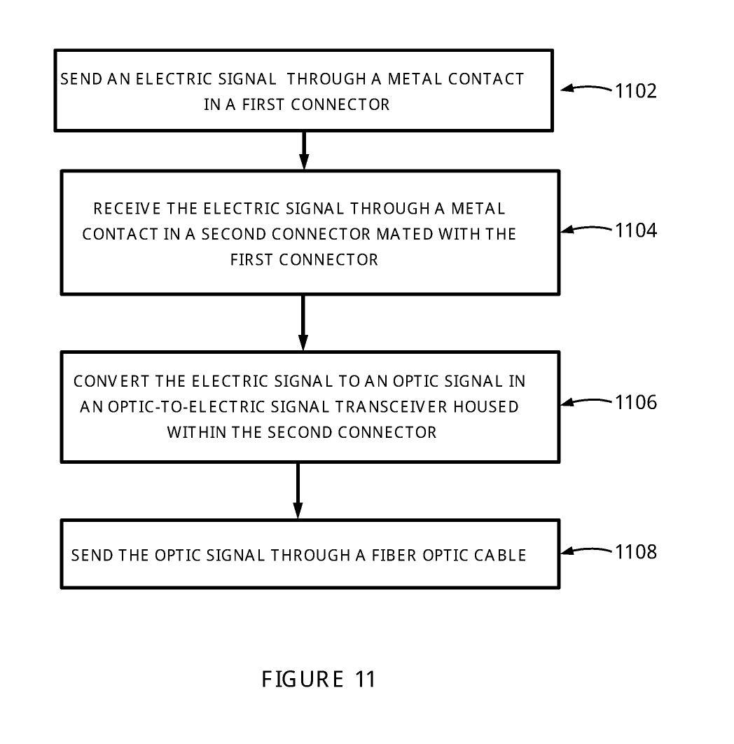

Reference is now made to FIG. 11, which is a simplified flow chart illustration of a method of sending a signal over fiber optic cable according to an example embodiment of the invention.

The method of FIG. 11 includes:

sending an electric signal through a metal contact in a first connector (1102);

receiving the electric signal through a metal contact in a second connector mated with the first connector (1104);

converting the electric signal to an optic signal in an optic-to-electric signal transceiver housed within the second connector (1106); and

sending the optic signal through a fiber optic cable (1108).

It is expected that during the life of a patent maturing from this application many relevant transceivers will be developed and the scope of the term transceivers is intended to include all such new technologies a priori.

As used herein the term “about” refers to ±10%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-32. (canceled)

33. A connector assembly for communicating data signals in a rugged environment comprising:
one or more electrical contacts, exposed through a waterproofing connector gasket on a front face of the connector assembly; and
an electro-optical transceiver, housed in the connector assembly, wherein the electro-optical transceiver is configured to perform at least one of transforming a first electrical signal, from the one or more electrical contacts to a first optical signal on the fiber optic cable, and transforming a second optical signal on the fiber optic cable to a second electrical signal on the one or more electrical contacts, and
wherein the connector assembly is configured to mate a second connector assembly, the mating of the two connector assemblies pushing out moisture to create one or more electrical connections between the one or more electrical contacts and one or more respective second electrical contacts of the second connector assembly.

34. The connector assembly of claim 33, wherein the fiber optic cable includes an electric power cable and wherein the connector assembly is further configured to provide power to the electro-optical transceiver from the electrical power cable.

35. The connector assembly of claim 34, further comprising an electric power contact exposed through the connector gasket on the front face of the connector assembly to provide power from the electrical power cable to a power-providing contact of the second connector assembly.

36. The connector assembly of claim 33, further comprising a power converter connectable to an external source of power, and connected to the electro-optical transceiver, to provide the power at a different voltage to the transceiver.

37. The connector assembly of claim 36, wherein the power converter is housed in the connector assembly and wherein the connector assembly further comprises an electric power contact exposed through the connector gasket to connect the power converter to the external power source.

38. The connector assembly of claim 36, in which the power converter accepts alternating current (AC) input power at any voltage ranging from 5 volts to 250 volts.

39. The connector assembly of claim 36, in which the power converter accepts direct current (DC) input power at any voltage ranging from 2 volts to 60 volts.

40. The connector assembly of claim 33, further comprising an insert support and an insert, the insert set inside the insert support and comprising passageways through which the electric contacts pass, wherein pressure applied on a front face of the insert causes the insert to compress against the insert support and against the electric contacts.

41. The connector assembly of claim 33, wherein the electro-optical transceivers are one of the following types:
SFP (Small Form-factor Pluggable);
SFP+ (advanced Small Form-factor Pluggable);
XFP (10 Gigabit Small Form-Factor Pluggable);
QSFP (Quad Small Form-factor Pluggable);
QSFP+ (advanced Quad Small Form-factor Pluggable);
CSFP (Compact Small Form-factor Pluggable);
CFP (C Form-factor Pluggable); and
CXP (advanced C form-factor Pluggable).

42. The connector assembly of claim 33, further comprising potting material to attach the connector assembly to the fiber optic cable.

43. A connector system for communicating data signals in a rugged environment, comprising first and second communication cables, each communication cable comprising:
a fiber optic cable;
a connector assembly, waterproofed with a connector gasket and attached to an end of the fiber optic cable;
one or more electrical contacts, housed in the connector assembly and exposed through the connector gasket; and
an electro-optical transceiver, housed in the connector assembly, wherein the electro-optical transceiver is configured to perform at least one of transforming a first electrical signal, from the one or more electrical contacts, to a first optical signal on the fiber optic cable, and transforming a second optical signal on the fiber optic cable to a second electrical signal on the one or more electrical contacts,
wherein the connector assemblies of the two communications cables are configured to mate, the mating of the two connector assemblies pushing out moisture to create one or more electrical connections between the respective electrical contacts of the two connector assemblies.

44. The connector system of claim 43, wherein the connector assembly of the first communications cable is at a distal end of the first communications cable, and further comprising an electric power cable, extending with the fiber optic cable from a proximal end of the first communications cable to the distal end, to provide power to the electro-optical transceivers of both the first and second communications cables.

45. The connector system of claim 44, wherein the electric power cable has a first exposed power contact extending through the distal connector assembly and electrically connectable to a second exposed power contact of the second communications cable.

46. The connector system of claim 45, further comprising a power converter, the power converter connected to the electric power cable to receive power, and further connected to at least one of the electro-optical transceivers, to provide the power at a different voltage to the at least one electro-optical transceiver.

47. A communications cable for communicating data signals in a rugged environment comprising:
an electric signal cable;
a first connector assembly, waterproofed by a connector gasket and attached to an end of the electric signal cable;
one or more electric contacts, housed in the first connector assembly and exposed through the connector gasket; and
an electric-to-electric transceiver, housed in the first connector assembly, wherein the electric-to-electric transceiver is configured to transform a first electrical signal, from the one or more electrical contacts to a second electric signal on the electric signal cable, and wherein the connector assembly is configured to mate a second connector assembly, the mating of the two connector assemblies pushing out moisture to create one or more electrical connections between the one or more electrical contacts and one or more respective second electrical contacts of the second connector assembly.

48. The communications cable of claim 47, in which the transceiver comprises an electric signal interface configured to one of the following standards:
RJ-45;
RS-232;
BNC;
USB;
HDMI.

49. A method of implementing a connector assembly for communicating data signals in a rugged environment comprising:
configuring the connector assembly with a waterproofing connector gasket and one or more electrical contacts that are exposed, through the connector gasket, on a front side of the first connector assembly;
configuring an electro-optical transceiver, housed in the connector assembly, to perform at least one of transforming a first electrical signal, from the one or more electrical contacts, to a first optical signal on a fiber optic cable, and transforming a second optical signal on the fiber optic cable to a second electrical signal on the one or more electrical contacts; and,
configuring the first connector assembly to mate a second connector assembly, the mating of the two connector assemblies pushing out moisture to create one or more electrical connections between the one or more electrical contacts and one or more respective second connector electrical contacts of the second connector assembly.

50. The method of claim 49, further comprising configuring a back side of the connector assembly to attach to the fiber optic cable.

51. The method of claim 49, wherein the connector assembly is a distal connector assembly attached to a distal end of the fiber optic cable, wherein the fiber optic cable further comprises a proximal connector assembly, and wherein the method further comprises:
providing an electric power cable extending with the fiber optic cable from the proximal connector assembly to the distal connector assembly;
configuring the electric power cable to provide power to the electro-optical transceiver; and,
exposing a proximal power contact through the proximal connector assembly to connect the electric power cable to an external, proximal power source.

52. The method of claim 51, further comprising providing a distal power contact electrically connected to the electric power cable and exposed through the connector gasket of the distal connector assembly to be electrically connectable to a power contact of the second connector assembly.

53. The method of claim 49, further comprising providing a power converter housed in the connector assembly, connectable to an electric power line to receive power, and connectable to the electro-optical transceiver, to provide the power at a different voltage to the transceiver.
